(19) United States
(12) Patent Application Publication
(10) Pub. No.: US 2026/0298180 A1
(43) Pub. Date: Oct. 1, 2026

(54) INTEGRATED FUEL SUPPLY AND INJECTION SYSTEM SUITABLE FOR AMMONIA-HYDROGEN BLENDING

(71) Applicant: TIANJIN UNIVERSITY, Tianjin (CN)

(72) Inventors: Jiaying PAN, Tianjin (CN); Jinguang LI, Tianjin (CN); Haiqiao WEI, Tianjin (CN); Xingqian MAO, Tianjin (CN); Lei WANG, Tianjin (CN); Shiduo WANG, Tianjin (CN)

(73) Assignee: TIANJIN UNIVERSITY, Tianjin (CN)

(21) Appl. No.: 19/534,854

(22) Filed: Feb. 10, 2026

Related U.S. Application Data
(63) Continuation of application No. PCT/CN2025/102978, filed on Jun. 24, 2025.

(30) Foreign Application Priority Data
Mar. 31, 2025 (CN) 202510390396.3

(51) Int. Cl. F02M 21/02

(52) U.S. Cl. CPC F02M 21/0245; F02M 21/0206; F02M 21/0221; F02M 21/0275

(57) ABSTRACT

An integrated fuel supply and injection system suitable for the ammonia-hydrogen blending is provided, including a fuel supply system, a fuel injection and ignition system, and an ECU; the fuel supply system includes an ammonia tank, a hydrogen tank, storage tanks, regulating valves and booster pumps; the fuel injection and ignition system includes a liquid ammonia high-pressure common rail, a hydrogen high-pressure common rail, an ammonia-hydrogen integrated injector, a hydrogen flow controller, and an spark plug; the ammonia-hydrogen integrated injector is equipped with a liquid ammonia needle valve and an ammonia-hydrogen blending fuel needle valve; an annular hydrogen cavity is designed around the ammonia-hydrogen mixing cavity to facilitate multi-hole injection, allowing hydrogen to dissolve into the liquid ammonia as nano-bubbles, thereby forming an ammonia-hydrogen blending fuel; ECU controls ammonia-hydrogen pre-blending fuel injection or hydrogen single-fuel injection, regulate ammonia/hydrogen mixing ratio, injecting pressure, quantity and moment.

### CROSS REFERENCE TO THE REPLATED APPLICATIONS

This application is a continuation application of the national phase entry of International Application No. PCT/CN2025/102978, filed on Jun. 24, 2025, which is based upon and claims priority to Chinese Patent Application No. 202510390396.3, filed on Mar. 31, 2025, the entire contents of which are incorporated herein by reference.

### TECHNICAL FIELD

The present invention relates to the technical field of heat energy and power engineering tests, in particular to the field of fuel supply and injection of internal combustion engines based on ammonia-hydrogen blending fuel.

### BACKGROUND

Ammonia, as the second largest industrially synthesized substance in the world, has well-developed industrial infrastructure related thereto. And ammonia has significant advantages when applied to internal combustion engines as carbon-neutral fuel. Ammonia has volumetric energy density higher than that of methane and hydrogen, and has advantages such as easy to liquefy, store and transport. However, the use of ammonia in internal combustion engines still faces significant challenges. Ammonia has a high autoignition temperature, high minimum ignition energy, a narrow flammability range, and a low flame propagation speed. Pure ammonia applied to internal combustion engines has poor combustion stability and large cycle variation. Therefore, ammonia is usually blended with other fuels for combustion. Hydrogen, as zero-carbon fuel, features a high flame propagation speed and a wider flammability range. It is usually blended with ammonia for combustion to improve the operational stability of engines.

Most of existing fuel supply systems for ammonia-hydrogen blended internal combustion engines (hereinafter referred as ICE) are designed with configurations such as ammonia port injection combined with in-cylinder direct hydrogen injection, or dual in-cylinder direct injection of ammonia and hydrogen. As for the configuration of ammonia port injection combined with in-cylinder direct hydrogen injection, liquid ammonia is rapidly transformed into gas after being injected into the intake port, reducing the charging efficiency and resulting in a decrease in output power of an engine. Dual in-cylinder direct injection of ammonia and hydrogen, which requires the arrangement of two fuel injector mounting holes in a cylinder head, increasing the complexity of equipment. Furthermore, the increase in the number of holes leads to a decrease in mechanical strength and rigidity. Independent injection of ammonia and hydrogen can also cause uneven distribution of blending gas in the cylinder, affecting the combustion stability. In addition, hydrogen is likely to leak due to the small size of hydrogen molecules, high diffusivity and hydrogen embrittlement characteristics, and the risk of hydrogen leakage is exacerbated in high-pressure systems.

### SUMMARY

As for the above prior art, the present invention provides an integrated fuel supply and injection system suitable for ammonia-hydrogen blending, which can achieve ammonia-hydrogen pre-blending injection and hydrogen single-fuel injection, adapt to change in working conditions of an engine, improve the uniformity of blending gas in a cylinder, solve the problem of difficulty in ammonia ignition, improve the combustion stability, reduce the complexity of equipment, and increase the output power of the engine.

In order to solve the above technical problems, the present invention provides an integrated fuel supply and injection system suitable for ammonia-hydrogen blending. The integrated fuel supply and injection system includes a fuel supply system, a fuel injection and ignition system, and an electronic control unit;

the fuel supply system includes an ammonia tank and a hydrogen tank, the ammonia tank is connected to a liquid ammonia storage tank through an ammonia regulating valve, and a hydrogen storage tank, a hydrogen booster pump, and a liquid ammonia booster pump are arranged in the liquid ammonia storage tank; the hydrogen tank is connected to the hydrogen storage tank through a hydrogen regulating valve; the fuel injection and ignition system includes a liquid ammonia high-pressure common rail, a hydrogen high-pressure common rail, an ammonia-hydrogen integrated injector, a hydrogen flow controller, and an spark plug; the liquid ammonia high-pressure common rail is provided with a liquid ammonia common rail pressure-limiting valve and a liquid ammonia rail pressure sensor; the hydrogen high-pressure common rail is provided with a hydrogen common rail pressure-limiting valve and a hydrogen rail pressure sensor;

the ammonia-hydrogen integrated injector includes an injector body, a liquid ammonia inlet is formed in a top of the injector body, and a liquid ammonia pipeline, a liquid ammonia injection orifice, an ammonia-hydrogen mixing cavity, an ammonia-hydrogen blending fuel chamber, a swirl nozzle, a stirring and cutting chamber, a flow guiding cavity, and an injection orifice are sequentially formed in the injector body from the liquid ammonia inlet in an axial direction in a downward communicated manner; a liquid ammonia needle valve is arranged in the liquid ammonia pipeline and located above the liquid ammonia injection orifice, a liquid ammonia needle valve spring is arranged on a top of the liquid ammonia needle valve, a liquid ammonia electromagnetic coil is arranged on the liquid ammonia needle valve in a surrounding manner, and the liquid ammonia electromagnetic coil is provided with a liquid ammonia electromagnetic coil electronic control wire led out of the injector body; a hydrogen cavity having an annular space is provided on the injector body at the position coplanar with the ammonia-hydrogen mixing cavity; a hydrogen inlet communicated with the hydrogen cavity is formed in a side wall of the injector body, and a plurality of hydrogen injection orifices are formed between the hydrogen cavity and the ammonia-hydrogen mixing cavity; an included angle of 90° is formed between the hydrogen injection orifice and the liquid ammonia injection orifice;

a plurality of helical blades and a plurality of stirring and cutting columns are arranged in the stirring and cutting chamber, a stirring and cutting chamber pressure sensor is arranged at a bottom of the stirring and cutting chamber, the stirring and cutting chamber pressure sensor is provided with a stirring and cutting chamber pressure sensor wire led out of the injector body, the bottom of the stirring and cutting chamber is connected with the flow guiding cavity via a conical cavity to the flow guiding cavity, an ammonia-hydrogen blending fuel needle valve is arranged in the flow guiding cavity, and the ammonia-hydrogen blending fuel needle valve and the liquid ammonia needle valve have the same structure;

a pump outlet of the liquid ammonia booster pump is connected to a fuel inlet of the liquid ammonia high-pressure common rail, and the liquid ammonia common rail pressure-limiting valve of the liquid ammonia high-pressure common rail is connected to the liquid ammonia storage tank; a fuel outlet of the liquid ammonia high-pressure common rail is connected to the liquid ammonia inlet of the ammonia-hydrogen integrated injector;

an outlet of the hydrogen storage tank is connected to a fuel inlet of the hydrogen high-pressure common rail after passing through the hydrogen booster pump, and the hydrogen common rail pressure-limiting valve of the hydrogen high-pressure common rail is connected to the hydrogen storage tank; a fuel outlet of the hydrogen high-pressure common rail is connected to the hydrogen inlet of the ammonia-hydrogen integrated injector through a hydrogen flow controller;

the ammonia-hydrogen integrated injector and the spark plug are mounted on a combustion chamber of an engine or a pre-chamber, and the pre-chamber is mounted on a cylinder head of the engine; and

the liquid ammonia rail pressure sensor, the hydrogen rail pressure sensor, the liquid ammonia booster pump, the hydrogen booster pump, the liquid ammonia common rail pressure-limiting valve, the hydrogen common rail pressure-limiting valve, the ammonia-hydrogen integrated injector, the hydrogen flow controller, and the spark plug are all connected to the electronic control unit (ECU), and the ECU receives signals from the liquid ammonia rail pressure sensor and the hydrogen rail pressure sensor, controls the liquid ammonia booster pump, the hydrogen booster pump, the liquid ammonia common rail pressure-limiting valve, the hydrogen common rail pressure-limiting valve, the ammonia-hydrogen integrated injector, the hydrogen flow controller, and the spark plug, controls injection pressure, an ammonia/hydrogen mixing ratio, an injection quantity, and an injection moment of ammonia-hydrogen blending fuel of the ammonia-hydrogen integrated injector, and controls ignition of the spark plug.

Furthermore, in the integrated fuel supply and injection system according to the present invention:

the liquid ammonia high-pressure common rail is used for supplying ammonia fuel of 30 MPa, and the hydrogen high-pressure common rail is used for supplying hydrogen fuel at 30 MPa.

Helical blade supporting columns are fixed on the side wall of the injector body at the position corresponding to the helical blades, the helical blades are fixed to the helical blade supporting columns, and the plurality of stirring and cutting columns are fixed to the side wall of the injector body around the helical blades.

An ammonia-hydrogen blending fuel needle valve spring is arranged on a top of the ammonia-hydrogen blending fuel needle valve, an ammonia-hydrogen blending fuel electromagnetic coil is arranged on the ammonia-hydrogen blending fuel needle valve in a surrounding manner, and the ammonia-hydrogen blending fuel electromagnetic coil is provided with an ammonia-hydrogen blending fuel electromagnetic coil electronic control wire led out of the injector body.

The ECU receives signals of the liquid ammonia high-pressure common rail and the hydrogen high-pressure common rail, and keeps pressure of the common rails at a target value; when the rail pressure is lower than a required injection pressure, the ECU controls the liquid ammonia booster pump and the hydrogen booster pump to work to boost ammonia fuel and hydrogen fuel; and when the rail pressure is higher than the required injection pressure, the ECU controls the liquid ammonia common rail pressure-limiting valve and the hydrogen common rail pressure-limiting valve to be opened to release pressure of common rail pipes, ammonia enters the liquid ammonia storage tank, and hydrogen enters the hydrogen storage tank.

The ammonia-hydrogen integrated injector comprises a liquid ammonia supply section, a hydrogen supply section, an ammonia-hydrogen mixing section, and an ammonia-hydrogen injection section. The liquid ammonia supply section comprises the liquid ammonia inlet, the liquid ammonia needle valve spring, the liquid ammonia needle valve, the liquid ammonia electromagnetic coil, and the liquid ammonia injection orifice. The hydrogen supply section comprises the hydrogen inlet, the hydrogen cavity, and the hydrogen injection orifices. The ammonia-hydrogen mixing section comprises the ammonia-hydrogen mixing cavity, the ammonia-hydrogen blending fuel chamber, the swirl nozzle, and the stirring and cutting columns and the helical blades in the stirring and cutting chamber. The ammonia-hydrogen injection section comprises the flow guiding cavity and the ammonia-hydrogen blending fuel needle valve. The ECU controls the quantity of ammonia fuel and the quantity of hydrogen fuel by regulating an opening duration of the liquid ammonia needle valve and an opening duration of the hydrogen flow controller, ammonia and hydrogen are blended in the ammonia-hydrogen mixing cavity, the ammonia/hydrogen mixing ratio is continuously variable, and then ammonia-hydrogen blending fuel or hydrogen fuel alone is injected into the engine or the pre-chamber. The ECU regulates an injection quantity and an injection moment of the ammonia-hydrogen blending fuel or hydrogen fuel alone by controlling the ammonia-hydrogen blending fuel needle valve according to working conditions of the engine.

Furthermore, the hydrogen storage tank, the hydrogen booster pump, and the liquid ammonia booster pump are arranged in the liquid ammonia storage tank. When hydrogen leakage occurs in the hydrogen storage tank and the hydrogen booster pump, hydrogen that leaks is sucked by the liquid ammonia booster pump in the liquid ammonia storage tank and supplied to the combustion chamber of the engine or pre-chamber.

The ECU controls the ammonia-hydrogen integrated injector to be in a single-fuel injection mode or a double-fuel injection mode according to the working conditions of the engine; when the engine is in cold boost, the ECU controls the liquid ammonia needle valve of the ammonia-hydrogen integrated injector to be closed and the hydrogen flow controller to be opened, at this moment, the ammonia-hydrogen integrated injector only supplies the hydrogen fuel, and the hydrogen fuel promotes the engine to be ignited and increases the temperature of the engine; and when temperature of the engine reaches normal operating temperature, the ECU controls the liquid ammonia needle valve of the ammonia-hydrogen integrated injector to be opened and the hydrogen flow controller to be opened and continuously regulates the opening duration of the liquid ammonia needle valve and the opening duration of the hydrogen flow controller according to the working conditions of the engine, so as to achieve real-time change in the ammonia/hydrogen mixing ratio and ensure stable and efficient combustion of the engine.

Compared with the prior art, the present invention has the following beneficial effects:
(1) By arranging the hydrogen storage tank, the hydrogen booster pump, and the liquid ammonia booster pump in the liquid ammonia storage tank, ammonia and hydrogen can be effectively prevented from leaking into environments, thereby ensuring safe operation of equipment.
(2) The ammonia-hydrogen integrated injector is designed, hydrogen is blended in the liquid ammonia in the form of the nano-bubbles in the injector to generate the ammonia-hydrogen blending fuel, the ammonia/hydrogen mixing ratio can be continuously regulated, the fuel supply equipment is simplified, and the mixing uniformity of ammonia and hydrogen is improved.
(3) The ammonia-hydrogen integrated injector can achieve two working modes, namely the hydrogen single-fuel injection mode and the ammonia-hydrogen double-fuel pre-blending injection mode. The hydrogen single-fuel injection mode is suitable for a cold boost stage of the engine, which can solve the problem of difficulty in cold boost; and the ammonia-hydrogen double-fuel pre-blending injection mode is used for a stable operation stage of the engine, achieving efficient operation of the engine.

### BRIEF DESCRIPTION OF THE DRAWINGS

FIG. 1 is a schematic structural diagram of an integrated fuel supply and injection system according to the present invention;

FIG. 2 is a schematic diagram of another mounting manner of an injector, an spark plug, and an engine in FIG. 1;

FIG. 3 is an axial sectional diagram of an ammonia-hydrogen integrated injector in the present invention; and

FIG. 4 is an enlarged sectional diagram of a sectioning position shown in A-A in FIG. 3.

In the drawings:

1-ammonia tank; 2-hydrogen tank; 3-ammonia regulating valve; 4-hydrogen regulating valve; 5-liquid ammonia storage tank; 6-hydrogen storage tank; 7-hydrogen booster pump; 8-liquid ammonia booster pump; 9-hydrogen common rail pressure-limiting valve; 10-hydrogen high-pressure common rail; 11-hydrogen rail pressure sensor; 12-liquid ammonia common rail pressure-limiting valve; 13-liquid ammonia high-pressure common rail; 14-liquid ammonia rail pressure sensor; 15-ammonia-hydrogen integrated injector; 16-spark plug; 17-engine; 18-hydrogen flow controller; 19- pre-chamber;

1501-liquid ammonia inlet; 1502-hydrogen inlet; 1503-injector body; 1504-liquid ammonia needle valve spring; 1505-liquid ammonia electromagnetic coil; 1506-liquid ammonia electromagnetic coil electronic control wire; 1507-liquid ammonia needle valve; 1508-stirring and cutting chamber pressure sensor wire; 1509-liquid ammonia injection orifice; 1510-hydrogen cavity; 1511-hydrogen injection orifice; 1512-ammonia-hydrogen mixing cavity; 1513-ammonia-hydrogen blending fuel chamber; 1514-swirl nozzle; 1515-stirring and cutting column; 1516-stirring and cutting chamber; 1517-helical blade; 1518-stirring and cutting chamber pressure sensor; 1519-flow guiding cavity; 1520-ammonia-hydrogen blending fuel electromagnetic coil electronic control wire; 1521-ammonia-hydrogen blending fuel needle valve; 1522-helical blade supporting column.

### DETAILED DESCRIPTION OF THE EMBODIMENTS

A design concept of an integrated fuel supply and injection system for ammonia-hydrogen blend provided by the present invention is as follows: during cold boost, only hydrogen fuel is supplied to an injector, and injection of gaseous fuel can be precisely controlled by the injector controlled electromagnetically, so as to solve the problem of difficulty in ignition during cold boost; when temperature reaches normal operating temperature, a liquid ammonia inlet of the injector starts to supply liquid ammonia, gaseous hydrogen is introduced when the liquid ammonia in the injector is injected at a high speed, hydrogen nano-bubbles are generated by strong shear induced by injection of the liquid ammonia, the gaseous hydrogen is blended in the liquid ammonia in a form of nano-bubbles, formed ammonia-hydrogen blended liquid fuel is injected into a cylinder by an electromagnetic needle valve at a bottom of the injector, and injection of the liquid fuel can also be precisely controlled by the injector controlled electromagnetically, thereby improving the charging efficiency and output power of an engine. Meanwhile, a hydrogen booster pump, a hydrogen storage tank, and a liquid ammonia booster pump are arranged in a liquid ammonia storage tank to boost supplied fuel, high-pressure hydrogen and ammonia can be recycled by the liquid ammonia storage tank in case of leakage, and fuel can be prevented from leaking into the atmosphere in this manner, thereby improving the safety of equipment.

The present invention is further described below with reference to drawings and specific embodiments, however, the following embodiments do not impose any limitations to the present invention.

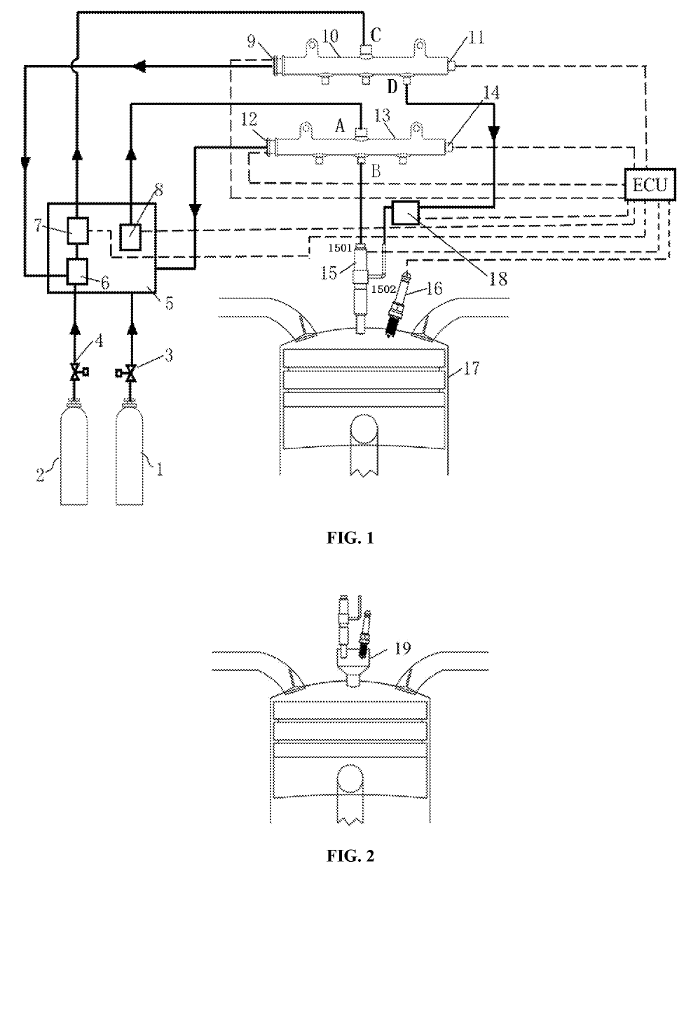

As shown in FIG. 1, an integrated fuel supply and injection system suitable for ammonia-hydrogen blending provided by the present invention mainly comprises a fuel supply system, a fuel injection and ignition system, and an ECU. The fuel supply system consists of an ammonia fuel supply system and a hydrogen fuel supply system. The ammonia fuel supply system includes an ammonia tank 1, an ammonia regulating valve 3 at an outlet of the ammonia tank, a liquid ammonia storage tank 5 and a liquid ammonia booster pump 8. The outlet of the ammonia tank 1 is connected to an inlet of the ammonia regulating valve 3, an outlet of the ammonia regulating valve 3 is connected to an inlet of the liquid ammonia storage tank 5, and the liquid ammonia booster pump 8 is arranged in the liquid ammonia storage tank 5. The hydrogen fuel supply system includes a hydrogen tank2, a hydrogen regulating valve 4 at an outlet of the hydrogen tank 2, a hydrogen storage tank 6, and a hydrogen booster pump 7. The outlet of the hydrogen tank 2 is connected to an inlet of the hydrogen regulating valve 4, an outlet of the hydrogen regulating valve 4 is connected to an inlet of the hydrogen storage tank 6, an outlet of the hydrogen storage tank 6 is connected to an inlet of the hydrogen booster pump 7, and the hydrogen storage tank 6, the hydrogen booster pump 7, and the liquid ammonia booster pump 8 are arranged in the liquid ammonia storage tank 5. When hydrogen leakage occurs in the hydrogen storage tank 6 and the hydrogen booster pump 7, the leaked hydrogen is sucked by the liquid ammonia booster pump 8 in the liquid ammonia storage tank 5 and supplied to a combustion chamber of an engine 17 or a pre-chamber 19.

The fuel injection and ignition system includes a hydrogen high-pressure common rail 10, a liquid ammonia high-pressure common rail 13, an ammonia-hydrogen integrated injector 15, a spark plug 16 and a hydrogen flow controller 18. An outlet of the liquid ammonia booster pump 8 is connected to a fuel inlet A of the liquid ammonia high-pressure common rail 13, and a fuel outlet B of the liquid ammonia high-pressure common rail 13 is connected to an ammonia inlet of the ammonia-hydrogen integrated injector 15. An outlet of the hydrogen booster pump 7 is connected to a fuel inlet C of the hydrogen high-pressure common rail 10, a fuel outlet D of the hydrogen high-pressure common rail 10 is connected to an inlet of the hydrogen flow controller 18, an outlet of the hydrogen flow controller 18 is connected to a hydrogen inlet 1502 of the ammonia-hydrogen integrated injector 15, and ammonia-hydrogen double-fuel or hydrogen single-fuel injected into the combustion chamber of the engine 17 or the pre-chamber 19 shown in FIG. 2, and ignited by the spark plug 16. Wherein the ammonia-hydrogen double-fuel is formed by blending ammonia and hydrogen in the ammonia-hydrogen integrated injector 15.

The ECU can change injection pressure, an ammonia/hydrogen mixing ratio, a total fuel injection quantity, an injection moment, ignition of the spark plug, and working modes of the ammonia-hydrogen integrated injector 15. A hydrogen rail pressure sensor 11 and a liquid ammonia rail pressure sensor 14 are connected to the ECU, and respectively transmit pressure signals of hydrogen and ammonia to the ECU, and the ECU controls the liquid ammonia booster pump 8 and the hydrogen booster pump 7 to work according to a target pressure value to boost fuel. When pressure release is required, the ECU controls a hydrogen common rail pressure-limiting valve 9 and a liquid ammonia common rail pressure-limiting valve 12 to be opened for pressure release, the hydrogen common rail pressure-limiting valve 9 is connected to the hydrogen storage tank 6, hydrogen enters the hydrogen storage tank 6 during pressure release, the liquid ammonia common rail pressure-limiting valve 12 is connected with the liquid ammonia storage tank 5, and ammonia enters the liquid ammonia storage tank 5 during pressure release. The ECU achieves two different fuel injection modes of the ammonia-hydrogen integrated injector 15 by controlling opening or closing state of a liquid ammonia needle valve 1507 and the hydrogen flow controller 18. During cold boost, the ECU controls the liquid ammonia needle valve 1507 to be closed and the hydrogen flow controller 18 to be opened, and the ammonia-hydrogen integrated injector 15 is in a hydrogen single-fuel injection mode, so as to ensure rapid boost; when temperature reaches normal operating temperature, the ECU controls the liquid ammonia needle valve 1507 in the ammonia-hydrogen integrated injector 15 to be opened and the hydrogen flow controller 18 to be opened, and the ammonia-hydrogen integrated injector 15 is in an ammonia-hydrogen double-fuel injection mode, so as to achieve efficient and stable operation. The ECU achieves change in the ammonia/hydrogen mixing ratio by controlling an opening duration of the liquid ammonia needle valve 1507 and an opening duration of the hydrogen flow controller 18 and achieves change in the injection moment and the total injection quantity by controlling an opening moment and an opening duration of an ammonia-hydrogen blending fuel needle valve 1521. The ECU achieves change in an ignition moment by controlling the spark plug 16.

FIG. 2 illustrates another mounting manner of the ammonia-hydrogen integrated injector 15, the spark plug 16, and the engine 17 in the embodiment in FIG. 1. The ammonia-hydrogen integrated injector 15 and the spark plug 16 are mounted on the pre-chamber 19, and the pre-chamber 19 is mounted on a cylinder head of the engine 17. In another embodiment, the ammonia-hydrogen integrated injector 15 and the spark plug 16 are mounted on the pre-chamber 19, and the pre-chamber 19 and the additional ammonia-hydrogen integrated injector 15 are mounted on the cylinder head of the engine 17.

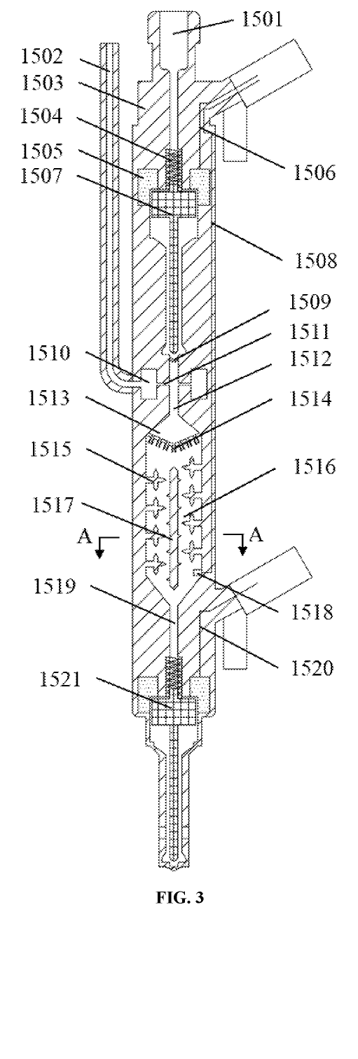

FIG. 3 is an axial sectional diagram of the ammonia-hydrogen integrated injector 15 in the present invention. As shown in FIG. 3, the ammonia-hydrogen integrated injector 15 comprise a liquid ammonia supply section, a hydrogen supply section, an ammonia-hydrogen mixing section, and an ammonia-hydrogen injection section. The liquid ammonia supply section comprise a liquid ammonia inlet 1501, an injector body 1503, a liquid ammonia needle valve spring 1504, a liquid ammonia electromagnetic coil 1505, a liquid ammonia needle valve 1507 and a liquid ammonia injection orifice 1509. The liquid ammonia injection orifice 1509 is of a single-hole structure, which can achieve high-speed injection of liquid ammonia. The hydrogen supply section comprises a hydrogen inlet 1502, a hydrogen cavity 1510, and hydrogen injection orifices 1511. The hydrogen cavity 1510 is an annular space, and a plurality of radial hydrogen injection orifices 1511 are formed between the hydrogen cavity 1510 and an ammonia-hydrogen mixing cavity 1512, that is, an included angle of 90° is formed between the hydrogen injection orifice 1511 and the liquid ammonia injection orifice 1509. The hydrogen cavity 1510 supplies constant-pressure hydrogen to injection holes of the plurality of hydrogen injection orifices 1511. The ammonia-hydrogen mixing section comprise the ammonia-hydrogen mixing cavity 1512, an ammonia-hydrogen blending fuel chamber 1513, a swirl nozzle 1514, stirring and cutting columns 1515 in a stirring and cutting chamber 1516, helical blades 1517 in the stirring and cutting chamber 1516, and a stirring and cutting chamber pressure sensor 1518. The swirl nozzle 1514 can helically inject ammonia-hydrogen blending fuel into the stirring and cutting chamber 1516 at a high speed, the four helical blades 1517 are located in a middle of the stirring and cutting chamber 1516, it is ensured that the ammonia-hydrogen blending fuel helically moves to a flow guiding cavity 1519 in the stirring and cutting chamber 1516, and the blending fuel continuously impacts the stirring and cutting columns 1515 during movement to generate nano-bubbles with smaller sizes. A head of the stirring and cutting column 1515 is of a conical structure, which can cut and impact the ammonia-hydrogen blending fuel over the maximum area. In order to inject ammonia and hydrogen into the stirring and cutting chamber 1516, the stirring and cutting chamber pressure sensor 1518 detects a pressure of the stirring and cutting chamber 1516, and it is ensured that the pressure of the stirring and cutting chamber 1516 is kept at 15 MPa, which has a significant pressure difference from the injection pressure of ammonia and hydrogen at 30 MPa. The ammonia-hydrogen injection section consists of the flow guiding cavity 1519 and the ammonia-hydrogen blending fuel needle valve 1521.

The liquid ammonia electromagnetic coil 1505, the stirring and cutting chamber pressure sensor 1518, and the ammonia-hydrogen blending fuel electromagnetic coil are provided with a liquid ammonia electromagnetic coil electronic control wire 1506, a stirring and cutting chamber pressure sensor wire 1508, and an ammonia-hydrogen blending fuel electromagnetic coil electronic control wire 1520 that are led out of the injector body 1503 respectively, and the above electronic control wires are all connected to the ECU.

Liquid ammonia is injected into the ammonia-hydrogen mixing cavity 1512 through the liquid ammonia injection orifice 1509 by controlling the liquid ammonia needle valve 1507 by the ECU, and hydrogen is injected into the ammonia-hydrogen mixing cavity 1512 through the hydrogen injection orifices 1511 by controlling the hydrogen flow controller 18 by the ECU, where an included angle of 90° is formed between the liquid ammonia injection orifice 1509 and the hydrogen injection orifice 1511, which is conducive to forming high shearing force with hydrogen when the liquid ammonia is injected at a high speed, ammonia-hydrogen blending fuel rich in hydrogen nano-bubbles is generated by mixing hydrogen and liquid ammonia, the nano-bubbles with smaller sizes are generated after the ammonia-hydrogen blending fuel is cut and impacted by the stirring and cutting columns 1515 in the stirring and cutting chamber 1516 and kept in a stable state, the ammonia-hydrogen blending fuel is finally supplied to the flow guiding cavity 1519 of the injector, the ammonia-hydrogen blending fuel is injected into the cylinder by the ammonia-hydrogen blending fuel needle valve 1521, and the ECU achieves change in different injection moments and injection quantity by controlling the opening moment and the opening duration of the ammonia-hydrogen blending fuel needle valve 1521.

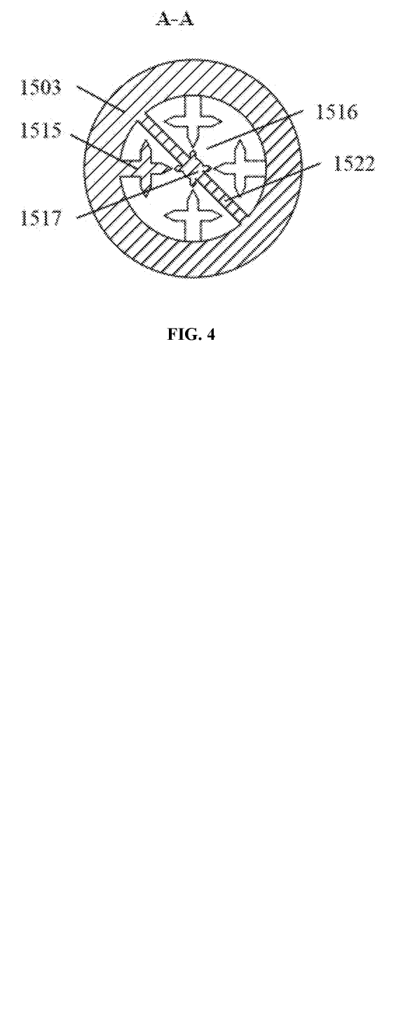

FIG. 4 is an enlarged sectional diagram of A-A of the ammonia-hydrogen integrated injector 15. It can be shown that the helical blades 1517 and a plurality of stirring and cutting columns 1515 are arranged in the stirring and cutting chamber 1516, helical blade supporting columns 1522 are fixed to a side wall, at positions where the helical blades 1517 are mounted, of the injector body 1503 (namely the stirring and cutting chamber 1516), the helical blades 1517 are fixed to the helical blade supporting columns 1522, and the plurality of stirring and cutting columns 1515 are fixed to the side wall of the injector body 1503 around the helical blades 1517. The helical blade supporting columns 1522 are connected to the injector body 1503 and the helical blades 1517 and used for fixing the helical blades 1517.

A specific operation process of the integrated fuel supply and injection system for ammonia-hydrogen blending provided by the present invention is as follows:

Step 1, during cold start, the ECU receives signals from the liquid ammonia rail pressure sensor 14 and the hydrogen rail pressure sensor 11 and regulates pressure of the liquid ammonia and hydrogen high-pressure common rails according to the target pressure value. When the rail pressure is lower than a required injection pressure, the ECU controls the booster pumps (including the liquid ammonia booster pump 8 and the hydrogen booster pump 7) to work to boost ammonia fuel and hydrogen fuel; and when the rail pressure is higher than the required injection pressure, the ECU controls the pressure-limiting valves (including the liquid ammonia common rail pressure-limiting valve 12 and the hydrogen common rail pressure-limiting valve 9) to be opened to release pressure of common rail pipes, ammonia enters the liquid ammonia storage tank 5, hydrogen enters the hydrogen storage tank 6, and the pressure is kept in the target value. As for the fuel injection and ignition system, the ECU controls the liquid ammonia needle valve 1507 of the ammonia-hydrogen integrated injector 15 to be closed and the hydrogen flow controller 18 to be opened, only the hydrogen high-pressure common rail 10 supplies hydrogen fuel to the ammonia-hydrogen integrated injector 15, and at this moment, the fuel single-fuel mode is achieved. Hydrogen is injected into the engine or the pre-chamber, and the ECU regulates the injection moment and injection quantity of the ammonia-hydrogen integrated injector 15 according to working conditions, and then controls ignition of the spark plug.

Step 2, after the engine is warmed up, the ECU controls the liquid ammonia needle valve 1507 to be opened and the hydrogen flow controller 18 to be opened, the liquid ammonia high-pressure common rail 13 and the hydrogen high-pressure common rail 10 supply liquid ammonia and gaseous hydrogen to the ammonia-hydrogen integrated injector 15 respectively, and this corresponding to the double-fuel mode. The opening duration of the liquid ammonia needle valve 1507 and the duration of the hydrogen flow controller 18 are regulated according to the working conditions of the engine, so as to achieve change in the quantity of the supplied ammonia fuel and hydrogen fuel, thereby regulating the ammonia/hydrogen mixing ratio. At this moment, liquid ammonia is injected into the ammonia-hydrogen mixing cavity 1512 through the liquid ammonia injection orifice 1509, and hydrogen is injected into the ammonia-hydrogen mixing cavity 1512 through the hydrogen injection orifices 1511, which is conducive to forming high shearing force with hydrogen when the liquid ammonia is injected at a high speed, ammonia-hydrogen blending fuel rich in hydrogen nano-bubbles is generated by mixing hydrogen and liquid ammonia, the nano-bubbles with smaller sizes are generated after the ammonia-hydrogen blending fuel is cut and impacted by the stirring and cutting columns 1515 in the stirring and cutting chamber 1516 and kept in a stable state, the ammonia-hydrogen blending fuel is finally injected into the combustion chamber of the engine 17 or the pre-chamber 19, and the ECU regulates the injection moment and injection quantity of the ammonia-hydrogen integrated injector 15 according to working conditions, and then controls ignition of the spark plug 16.

In the present invention, the leakage risk is reduced by putting the hydrogen storage tank 6, the hydrogen booster pump 7, and the liquid ammonia booster pump 8 in the liquid ammonia storage tank 5, thereby preventing safety accidents. In the present invention, ammonia and hydrogen are blended in the injector through the designed ammonia-hydrogen integrated injector 15, meanwhile, the hydrogen single-fuel operating mode during cold boost and the ammonia-hydrogen pre-blending double-fuel operating mode during a heat engine can be achieved, the problems of difficulty in ammonia ignition and poor combustion stability are solved, and the output power of the engine is improved.

Although the present invention is described above with reference to the drawings, the present invention is not limited to the above specific implementations, and the above specific implementations are only schematic instead of restrictive. Those ordinarily skilled in the art may also make many improvements and changes without departing from the purpose of the present invention under the inspiration of the present invention, which all fall within the scope of protection of the present invention.

What is claimed is:

1. An integrated fuel supply and injection system suitable for ammonia-hydrogen blending, wherein the integrated fuel supply and injection system comprises a fuel supply system, a fuel injection and ignition system, and an electronic control unit;
the fuel supply system comprises an ammonia tank and a hydrogen tank, the ammonia tank is connected to a liquid ammonia storage tank through an ammonia regulating valve, and a hydrogen storage tank, a hydrogen booster pump, and a liquid ammonia booster pump are arranged in the liquid ammonia storage tank; the hydrogen tank is connected to the hydrogen storage tank through a hydrogen regulating valve;
the fuel injection and ignition system comprises a liquid ammonia high-pressure common rail, a hydrogen high-pressure common rail, an ammonia-hydrogen integrated injector, a hydrogen flow controller, and a spark plug;
the liquid ammonia high-pressure common rail is provided with a liquid ammonia common rail pressure-limiting valve and a liquid ammonia rail pressure sensor;
the hydrogen high-pressure common rail is provided with a hydrogen common rail pressure-limiting valve and a hydrogen rail pressure sensor;
the ammonia-hydrogen integrated injector comprises an injector body, a liquid ammonia inlet is formed in a top of the injector body, and a liquid ammonia pipeline, a liquid ammonia injection orifice, an ammonia-hydrogen mixing cavity, an ammonia-hydrogen blending fuel chamber, a swirl nozzle, a stirring and cutting chamber, a flow guiding cavity, and an injection orifice are sequentially formed in the injector body from the liquid ammonia inlet in an axial direction in a downward communicated manner; a liquid ammonia needle valve is arranged in the liquid ammonia pipeline and located above the liquid ammonia injection orifice, a liquid ammonia needle valve spring is arranged on a top of the liquid ammonia needle valve, a liquid ammonia electromagnetic coil is arranged on the liquid ammonia needle valve in a surrounding manner, and the liquid ammonia electromagnetic coil is provided with a liquid ammonia electromagnetic coil electronic control wire led out of the injector body; a hydrogen cavity having an annular space is provided on the injector body at a position coplanar with the ammonia-hydrogen mixing cavity; a hydrogen inlet communicated with the hydrogen cavity is formed in a side wall of the injector body, and a plurality of hydrogen injection orifices are formed between the hydrogen cavity and the ammonia-hydrogen mixing cavity; an included angle of 90° is formed between the hydrogen injection orifices and the liquid ammonia injection orifice;
a plurality of helical blades and a plurality of stirring and cutting columns are arranged in the stirring and cutting chamber, a stirring and cutting chamber pressure sensor is arranged at a bottom of the stirring and cutting chamber, the stirring and cutting chamber pressure sensor is provided with a stirring and cutting chamber pressure sensor wire led out of the injector body, the bottom of the stirring and cutting chamber is connected with the flow guiding cavity via a conical cavity, an ammonia-hydrogen blending fuel needle valve is arranged in the flow guiding cavity, and the ammonia-hydrogen blending fuel needle valve and the liquid ammonia needle valve have a same structure;
a pump outlet of the liquid ammonia booster pump is connected to a first fuel inlet of the liquid ammonia high-pressure common rail, and the liquid ammonia common rail pressure-limiting valve of the liquid ammonia high-pressure common rail is connected to the liquid ammonia storage tank; a second fuel outlet of the liquid ammonia high-pressure common rail is connected to the liquid ammonia inlet of the ammonia-hydrogen integrated injector;
an outlet of the hydrogen storage tank is connected to a first fuel inlet of the hydrogen high-pressure common rail after passing through the hydrogen booster pump, and the hydrogen common rail pressure-limiting valve of the hydrogen high-pressure common rail is connected to the hydrogen storage tank; a second fuel outlet of the hydrogen high-pressure common rail is connected to the hydrogen inlet of the ammonia-hydrogen integrated injector through a hydrogen flow controller;
the ammonia-hydrogen integrated injector and the spark plug are mounted on a combustion chamber of an engine or a pre-chamber, and the pre-chamber is mounted on a cylinder head of the engine; and
the liquid ammonia rail pressure sensor, the hydrogen rail pressure sensor, the liquid ammonia booster pump, the hydrogen booster pump, the liquid ammonia common rail pressure-limiting valve, the hydrogen common rail pressure-limiting valve, the ammonia-hydrogen integrated injector, the hydrogen flow controller, and the spark plug are all connected to the electronic control unit (ECU), and the ECU receives signals from the liquid ammonia rail pressure sensor and the hydrogen rail pressure sensor, controls the liquid ammonia booster pump, the hydrogen booster pump, the liquid ammonia common rail pressure-limiting valve, the hydrogen common rail pressure-limiting valve, the ammonia-hydrogen integrated injector, the hydrogen flow controller, and the spark plug, hydrogen is blended in liquid ammonia in a form of nano-bubbles in the ammonia-hydrogen mixing cavity to generate ammonia-hydrogen blending fuel, controls injection pressure, an ammonia/hydrogen mixing ratio, an injection quantity, and an injection moment of the ammonia-hydrogen blending fuel of the ammonia-hydrogen integrated injector, and controls ignition of the spark plug.

2. The integrated fuel supply and injection system suitable for the ammonia-hydrogen blending according to claim 1, wherein the liquid ammonia high-pressure common rail is used for supplying ammonia fuel of 30 MPa, and the hydrogen high-pressure common rail is used for supplying hydrogen fuel at 30 MPa.

3. The integrated fuel supply and injection system suitable for the ammonia-hydrogen blending according to claim 1, wherein helical blade supporting columns are fixed on the side wall of the injector body at a position corresponding to the helical blades, the helical blades are fixed to the helical blade supporting columns, and the plurality of stirring and cutting columns are fixed to the side wall of the injector body around the helical blades.

4. The integrated fuel supply and injection system suitable for the ammonia-hydrogen blending according to claim 1, wherein an ammonia-hydrogen blending fuel needle valve spring is arranged on a top of the ammonia-hydrogen blending fuel needle valve, an ammonia-hydrogen blending fuel electromagnetic coil is arranged on the ammonia-hydrogen blending fuel needle valve in a surrounding manner, and the ammonia-hydrogen blending fuel electromagnetic coil is provided with an ammonia-hydrogen blending fuel electromagnetic coil electronic control wire led out of the injector body.

5. The integrated fuel supply and injection system suitable for the ammonia-hydrogen blending according to claim 1, wherein the ECU receives signals of the liquid ammonia high-pressure common rail and the hydrogen high-pressure common rail, and keeps pressure of common rails at a target value; when a rail pressure is lower than a required injection pressure, the ECU controls the liquid ammonia booster pump and the hydrogen booster pump to work to boost ammonia fuel and hydrogen fuel; and when the rail pressure is higher than the required injection pressure, the ECU controls the liquid ammonia common rail pressure-limiting valve and the hydrogen common rail pressure-limiting valve to be opened to release pressure of common rail pipes, ammonia enters the liquid ammonia storage tank, and hydrogen enters the hydrogen storage tank.

6. The integrated fuel supply and injection system suitable for the ammonia-hydrogen blending according to claim 1, wherein the ammonia-hydrogen integrated injector comprises a liquid ammonia supply section, a hydrogen supply section, an ammonia-hydrogen mixing section, and an ammonia-hydrogen injection section; the liquid ammonia supply section comprises the liquid ammonia inlet, the liquid ammonia needle valve spring, the liquid ammonia needle valve, the liquid ammonia electromagnetic coil, and the liquid ammonia injection orifice; the hydrogen supply section comprises the hydrogen inlet, the hydrogen cavity, and the hydrogen injection orifices; the ammonia-hydrogen mixing section comprises the ammonia-hydrogen mixing cavity, the ammonia-hydrogen blending fuel chamber, the swirl nozzle, and the stirring and cutting columns and the helical blades in the stirring and cutting chamber; the ammonia-hydrogen injection section comprises the flow guiding cavity and the ammonia-hydrogen blending fuel needle valve; the ECU controls a quantity of ammonia fuel and a quantity of hydrogen fuel by regulating an opening duration of the liquid ammonia needle valve and an opening duration of the hydrogen flow controller, hydrogen is blended in the liquid ammonia in the form of the nano-bubbles in the ammonia-hydrogen mixing cavity to generate the ammonia-hydrogen blending fuel; and the ammonia/hydrogen mixing ratio is continuously variable, and then the ammonia-hydrogen blending fuel or the hydrogen fuel alone is injected into the engine or the pre-chamber; the ECU regulates an injection quantity and an injection moment of the ammonia-hydrogen blending fuel or the hydrogen fuel alone by controlling the ammonia-hydrogen blending fuel needle valve according to working conditions of the engine;
as for mixing of ammonia and hydrogen in the injector, gaseous hydrogen is blended in the liquid ammonia in the form of the nano-bubbles, specifically including that the liquid ammonia forms high shearing force with the hydrogen when injected in the ammonia-hydrogen mixing cavity at a high speed, the ammonia-hydrogen blending fuel rich in hydrogen nano-bubbles is generated by mixing the hydrogen and the liquid ammonia, nano-bubbles with smaller sizes are generated after the ammonia-hydrogen blending fuel is cut and impacted by the stirring and cutting columns in the stirring and cutting chamber and kept in a stable state, the ammonia-hydrogen blending fuel is finally supplied to the flow guiding cavity of the injector, the ammonia-hydrogen blending fuel is injected into a cylinder by the ammonia-hydrogen blending fuel needle valve, and the ECU achieves change at different injection moments and injection quantity by controlling an opening moment and an opening duration of the ammonia-hydrogen blending fuel needle valve.

7. The integrated fuel supply and injection system suitable for the ammonia-hydrogen blending according to claim 1, wherein the ECU controls the ammonia-hydrogen integrated injector to be in a single-fuel injection mode or a double-fuel injection mode according to working conditions of the engine;
when the engine is in cold boost, the ECU controls the liquid ammonia needle valve of the ammonia-hydrogen integrated injector to be closed and the hydrogen flow controller to be opened, at this moment, the ammonia-hydrogen integrated injector only supplies hydrogen fuel, and the hydrogen fuel promotes the engine to be ignited and increases temperature of the engine; and
when the temperature of the engine reaches normal operating temperature, the ECU controls the liquid ammonia needle valve of the ammonia-hydrogen integrated injector to be opened and the hydrogen flow controller to be opened and continuously regulates the opening duration of the liquid ammonia needle valve and the opening duration of the hydrogen flow controller according to the working conditions of the engine, so as to achieve real-time change in the ammonia/hydrogen mixing ratio and ensure stable and efficient combustion of the engine.

8. The integrated fuel supply and injection system suitable for the ammonia-hydrogen blending according to claim 1, wherein the hydrogen storage tank, the hydrogen booster pump, and the liquid ammonia booster pump are arranged in the liquid ammonia storage tank; when hydrogen leakage occurs in the hydrogen storage tank and the hydrogen booster pump, hydrogen that leaks is sucked by the liquid ammonia booster pump in the liquid ammonia storage tank and supplied to the combustion chamber of the engine or pre-chamber.
